(19) United States
(12) Patent Application Publication
(10) Pub. No.: US 2018/0253267 A1
(43) Pub. Date: Sep. 6, 2018

(54) Thermal Printer For A Video Terminal

(71) Applicant: Nanoptix Inc., Dieppe (CA)

(72) Inventors: Daniel Vienneau, Dieppe (CA); Michel Vienneau, Dieppe (CA); Sean Moffat, Dieppe (CA)

(21) Appl. No.: 15/910,244

(22) Filed: Mar. 2, 2018

Related U.S. Application Data
(60) Provisional application No. 62/466,665, filed on Mar. 3, 2017.

(51) Int. Cl. G06F 3/12; H04N 1/00

(52) U.S. Cl. CPC G06F 3/1236; G06F 3/1228; H04N 1/00283

(57) ABSTRACT

A thermal printer thermal having a processor allowing the thermal printer to act as a host or a slave based on real time computing while being used in a video terminal.

### CROSS-REFERENCE TO RELATED APPLICATIONS

This application claims priority to U.S. Provisional Application No. 62/466,665, filed Mar. 3, 2017, the entire disclosure of which is hereby incorporated by reference herein.

### FIELD OF THE INVENTION

The present invention relates to thermal printers and more specifically to a thermal printer having a processor allowing the thermal printer to act as a host or a slave based on real time computing while being used in a video terminal.

### BACKGROUND OF THE INVENTION

The present invention pertains to thermal printers which are commonly used in gaming machines. Thermal printers in gaming machines have their processors to be slaves receiving communications from a host in order to print tickets based on commands from the gaming machine. In other words, the thermal printer processor simply follows commands as instructed.

There is no thermal printer in the gaming industry allowing the thermal printer processor to also act as a host allowing for commands to be sent to peripherals connected to the thermal printer such as HDMI, Wi-Fi, Bluetooth and other external applications to the thermal printer.

An open source architecture such as Linux is an ideal operating system for various applications. However, the Linux Architecture is not structured to run real time applications which are needed in order to control hardware used in thermal printers to print tickets from a gaming machine. The control also has to be in real time when tickets are printed from thermal printers in gaming machines.

There is therefore a need for a thermal printer which can be a host and can switch to a slave or vice versa using an open source code such as a Linux Architecture.

### SUMMARY OF INVENTION

The present invention provides a thermal printer for a video terminal wherein the thermal printer processor is able to be send host communications or to receive slave communications.

In a first aspect, the present invention provides a thermal printer for a video terminal which can act as a host and send host communications to applications connected to the thermal printer peripheries such as Wi-Fi, HDMI, Bluetooth. The thermal printer processor also act as a slave allowing to receive host communications from a gaming machine allowing the printing of gaming tickets in a video terminal.

### BRIEF DESCRIPTION OF THE DRAWINGS

The embodiments of the present invention will now be described by reference to the following FIGURES, in which identical reference numerals in different FIGURES indicate identical elements and in which:

FIG. 1 is a schematic drawing showing a thermal printer of the present invention according to one embodiment being connected to a gaming machine in order to receive host communications as well as being connected to independent applications to receive host communications from the thermal printer.

The FIGURES are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention.

### DETAILED DESCRIPTION OF THE INVENTION

The terms “coupled” and “connected”, along with their derivatives, may be used herein. It should be understood that these terms are not intended as synonyms for each other. Rather, in particular embodiments, “connected” may be used to indicate that two or more elements are in direct physical or electrical contact with each other. “Coupled” may be used to indicated that two or more elements are in either direct or indirect (with other intervening elements between them) physical or electrical contact with each other, or that the two or more elements co-operate or interact with each other (e.g. as in a cause and effect relationship).

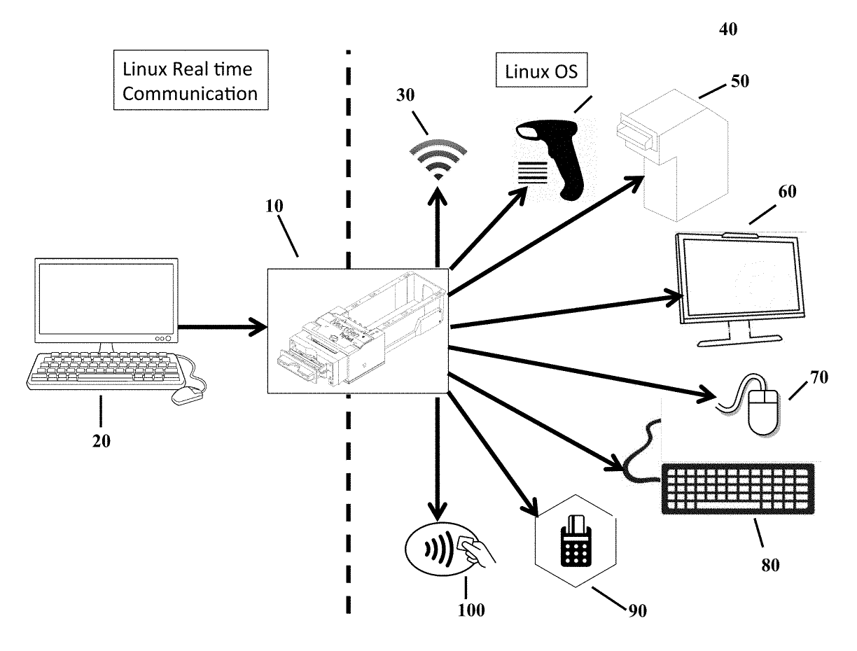

With reference to FIG. 1 and according to one embodiment of the present invention, a thermal printer 10 is shown being connected to a gaming machine 20. The communication between the thermal printer 10 and the gaming machine 20 is based on the thermal printer 10 being a slave which receives host communications from the gaming machine 20. The host communications from the gaming machine 20 to the thermal printer 10 is mainly for the printing of gaming tickets. It is possible that other host communications could be sent to the thermal printer 10 and is not limited to printing communications. The host can communicate with the slave and request the thermal printer 10 to act as a host to redirect some requests. The thermal printer 10 will communicate with appropriate slaves and report back to the host requesting the redirect enquiries.

With further reference to FIG. 1 and according to one embodiment of the present invention, the thermal printer 10 is shown being connected to a number of independent applications such as Wi-Fi application 30, a scanner 40, a bill validator 50, a screen 60, a mouse 70, a keyboard 80, a card reader 90 and a tap application 100 for either crediting or redeeming money from gaming machine 20. The independent applications receive host communications from the thermal printer 10 which acts as a host and the independent applications act as slaves. The thermal printer has a processor having a Linux open source architecture allowing the host communications to be sent from the thermal printer 10 to the independent applications. A worker skilled in the relevant art would be familiar with the required operating system based on a Linux open source architecture which would allow host communications to be sent from the thermal printer processor to the independent applications.

A thermal printer has a processor allowing the thermal printer to complete and receive various communications. In order to operate properly requires real time computing. A worker skilled in the relevant art would be familiar with the requirements of real time computing. In a thermal printer real time computing can be used to control the stepping of the motor for displacing the paper for printing a ticket, reading of various critical input sensors as well as control the thermal printing head for example.

The use of a real time environment in a thermal printer allows to ensure all printing functions are under absolute control when certain events occur. The requirement for absolute control is based on various gaming regulations as implemented by various legislative authorities. For example, when a ticket is printed with critical data after being instructed by a host (gaming machine), it is critical the printer's processor detects the location of the paper upon being instructed in order to notify the host that the printing of the ticket with the critical data has occurred. The thermal printer 10 has a main function of printing tickets which needs to be done through real time computing. Other applications which can be conducted by the thermal printer's processor such as communicate via USB, Serial, Ethernet or Bluetooth, and to provide support for various other applications, such as hosting print server or acting as a self-service terminal can be done through the use of a Linux operating system (OS). Linux is an open source operating system that has numerous software packages that can provide and facilitate theses requirements, however it does not provide the real time computing environment required to complete thermal printing in a thermal printer.

To meet the combined requirements such as being a slave for printing purposes (real time computing) and to be a host to send host communications to independent applications, the thermal printer has various Linux drivers which utilizes the thermal printer processor peripherals.

During the printing process when the thermal printer is a slave and to ensure the feeding of paper in the printer without potential missing steps and to properly accelerate and decelerate the movement of paper within the thermal printing head real time computing is done by using the thermal printer processor's Pulse Width Modulation (PWM) module. The thermal printer processor can use this module to ensure the two phases of the stepper motor in the thermal printer are toggled at the proper frequency and for the proper interval, since the thermal printer processor's PWM module will control the actual output, and on each transition the thermal printer processor will receive an interrupt. On the receipt of an interrupt, the thermal printer processor will reconfigure the PWM module for a new speed. Due to the behaviours of the PWM module these changes will be set in the next period. This setup provides the required real time like control of the stepper motor.

To ensure the thermal printing head is properly energised, a processor timer within the timer (or can be a separate timer) is used to enable an output to be toggled exactly at a microsecond interval. This peripheral on the thermal printer processor can be used to ensure an output is enabled/disabled for an exact time period. To properly print the paper is heated/energized for specific time periods based on the printing requirements. The setup of this timer occurs when the previously mentioned PWM module indicates a step has occurred via an interrupt. In the interrupt handler after a setup for the next step, the thermal printer processor configures the timer to ensure the thermal print head is energized for the exact time requirements.

Various critical sensors are connected to the analog to digital convertor (ADC) of the thermal printer. A Linux kernel driver is also connected to the ADC in order to continuously sample the processors ADC module to ensure the latest ADC reading is the reading which is being acted upon in the PWM's interrupt and other contexts. The Linux kernel driver enables the ADC peripheral to continuously sample the analog input and to trigger an interrupt upon completion to update the driver's copy of the sensor's value. For example, at every step (of the stepper motor feeder), the processor has to read the current print head temperature and the actual voltage and then compensate for the heating value of the pixel to burn. Typically, the print head temperature will rise as a ticket is printed. The voltage may also vary, depending on how many pixels were burnt on the last line.

The use of a Linux open architecture also allows an easy implementation of various USB device protocols with the USB Gadget Function interface. This framework allows the printer to implement various USB communication protocol and to select what is appropriate at run time. For example, the thermal printer can be instructed to be a USB Printer and CDC/USB Serial device simultaneously, or as either being independent depending on the host's requirements.

The term video terminal under the present invention can be defined as a gaming machine, a kiosk terminal or any other type of terminal which requires the use of a thermal printer.

The term thermal printer peripherals under the present invention can be defined as serial connections, USB connections and Ethernet connections for example and as would be known by a worker skilled in the relevant art.

The term Independent applications under the present invention can be defined as USB-on-the-go, HDMI, Wi-Fi, Bluetooth, TTL and serial communications to be directly connected to a series of peripherals such as Bar Code Scanners, RFID Readers, Smart Card Readers, Bill Validators, Video Monitors, Touch Screen

A person understanding this invention may now conceive of alternative structures and embodiments or variations of the above all of which are intended to fall within the scope of the invention as defined in the claims that follow.

What is claimed is:

1. A thermal printer for a video terminal comprising:
a processor having:
i) slave communication configuration based on a linux architecture having real time computing to control printing activities on the thermal printer; and
ii) A host communication configuration allowing connectivity to independent applications
Wherein the processor is able to interchange communications mode from being a host to a slave as well as a slave to a host.

2. Any invention as described in the description of this invention.
